(19) United States
(12) Patent Application Publication
(10) Pub. No.: US 2004/0264910 A1
(43) Pub. Date: Dec. 30, 2004

(54) Optical antenna

(76) Inventors: Toshiaki Suzuki, Suwa-gun (JP); Koichi Takahashi, Tokyo (JP)

Correspondence Address: KENYON & KENYON, 1500 K STREET, N.W., SUITE 700, WASHINGTON, DC, 20005, US

(21) Appl. No.: 10/872,498

(22) Filed: Jun. 22, 2004

(30) Foreign Application Priority Data
Jun. 24, 2003 (JP) 2003-179645

(51) Int. Cl. G02B 6/26

(52) U.S. Cl. 385/146; 385/31

(57) ABSTRACT

An optical antenna is formed by a flat board optical guide member which has an incidence surface (15) on a surface in a thickness direction and an emergence surface (12) on the other surface; a light condensing member (13) which is disposed so as to face the emergence surface of the optical guide member (11), a light receiving element which is disposed in a light condensing position in the light condensing member. A slanted surface (17) for reflecting a total incident light on a back surface (16) of the optical guide member is formed so as to direct the reflected incident light toward the emergence surface. By doing this, it is possible to form a light-weight optical antenna for receiving the signal light in which it is possible to align the optical axis with the signal light.

The present application is based on patent application No. 2003-179645 filed Jun. 24, 2003 in Japan, the content of which is incorporated herein by reference.

### BACKGROUND OF THE INVENTION

1. Field of the Invention

The present invention relates to an optical antenna for receiving a signal light in an optical aerial transmission communication system.

2. Description of Related Art

Conventionally, there has been an optical antenna which is provided with an optical detection device for restricting a loss in a signal light (for example, see Japanese Unexamined Patent Application, First Publication No. Hei 8-148703). The optical detection device which is disclosed in the Japanese Unexamined Patent Application, First Publication No. Hei 8-148703 is provided with a waveguide tube and a light receiving element which is disposed on an end of the waveguide tube. Also, radius of the waveguide tube is smaller nearer to the light receiving element from an aperture. Furthermore, an inner space of the waveguide tube is filled by a core layer and a cladding layer which covers an outside of the core layer. Here, a refractive index of the core layer is higher than a refractive index of the cladding layer. That is, a signal light which is incident into an aperture of the waveguide tube is totally reflected on a border surfaces of the core layer and the cladding layer repeatedly so as to be transmitted in the core layer. Therefore, the signal light which reaches to the light receiving element is detected by the light receiving element.

However, it is necessary to form a beam diameter of a signal light beam such that the signal light beam should not scatter due to a middle-distance refraction in an optical aerial transmitting system such as an inter-building communication; thus, a communication is performed by a light which has several tens mm of beam diameter. If an aperture of the waveguide tube is enlarged so as to correspond to the light beam diameter, inner diameters of the core layer and the cladding layer increase. Also, a special material member such as sapphire, ZnS, and ZnSe is used for such a medium; therefore, an optical antenna itself is expensive.

On the other hand, it is acceptable if the diameter of the signal light beam may be small in a case in which a communication is performed in s short-distance communication such as an in-house optical wireless LAN; thus, it is acceptable if a diameter of a port of the waveguide tube may be small. However, if the diameter of a port of the waveguide tube is small, there occurs a total reflection on a border surface between the core layer and the cladding layer correspondingly.

### SUMMARY OF THE INVENTION

The present invention provides an optical antenna which comprises a flat board optical guide member which has an indicence surface on a surface in a thickness direction and an emergence surface on the other surface; a light condensing member which is disposed so as to face the emergence surface of the optical guide member, a light receiving element which is disposed in a light condensing position in the light condensing member, such that a slanted surface for reflecting a total incident light on a back surface of the optical guide member so as to direct the reflected incident light toward the emergence surface.

In the present invention, it is preferable that a plurality of the slanted surfaces are disposed in an optical antenna so as to have intervals in a direction toward the emergence surface.

In the present invention, it is preferable that slanted surface has and angle of 45° with reference to a back surface of the optical guide member.

In the present invention, it is preferable that a partial concave section is disposed on the incidence surface and the slanted surface is disposed inside of the concave section.

In the present invention, it is preferable that a reflecting coating is formed on the slanted surface.

In the present invention, it is preferable that he slanted surface is formed in a circular shape such that the diameter of the circle is smaller nearer to the emergence surface.

In the present invention, it is preferable that the optical guide member is formed in a sector such that a width of the optical guide member is narrower nearer to the emergence surface; and a reflecting coating is formed on a side surfaces on both ends of the width direction.

In the present invention, it is referable that the light condensing member is provided with a taper optical waveguide member which is cemented to the emergence surface and a focusing lens for focusing a light which is emitted from the taper optical guiding member on a light receiving element.

In the present invention, it is preferable that the light condensing member is formed by optical element which has different focal distance in a width direction and a thickness direction of the optical guide member.

In the present invention, it is preferable that a light condensing lens for condensing a light on the slanted surface is disposed in a front stage of the incidence surface.

### BRIEF DESCRIPTION OF THE DRAWINGS

FIGS. 1A and 1B show an optical antenna according to a first embodiment of the present invention. FIG. 1A is a view for a general structure. FIG. 1B is a cross section for a waveguide board.

FIG. 2 is a view for a general structure for a case in which the optical antenna shown in FIGS. 1A and 1B are mounted on a base board.

FIG. 3 is a view for a general structure of the optical antenna according to a second embodiment of the present invention.

FIG. 4 is a view for a general structure of the optical antenna according to a third embodiment of the present invention.

FIG. 5 is a view for a general structure of the optical antenna according to a fourth embodiment of the present invention.

FIGS. 6A to 6C show an optical antenna according to a fifth embodiment of the present invention. FIG. 6A is a view for a general structure. FIG. 1B is a cross section for a sector waveguide board. FIG. 6C is a cross section for a sector waveguide board.

FIG. 7 is a view for a general structure for a case in which the optical antenna of the present invention is used for receiving an optical wireless broadcasting program from a neighborhood building.

FIG. 8 is a view for a general structure for a case in which the optical antenna of the present invention is used for an optical aerial transmission communication system such as an in-house optical wireless LAN.

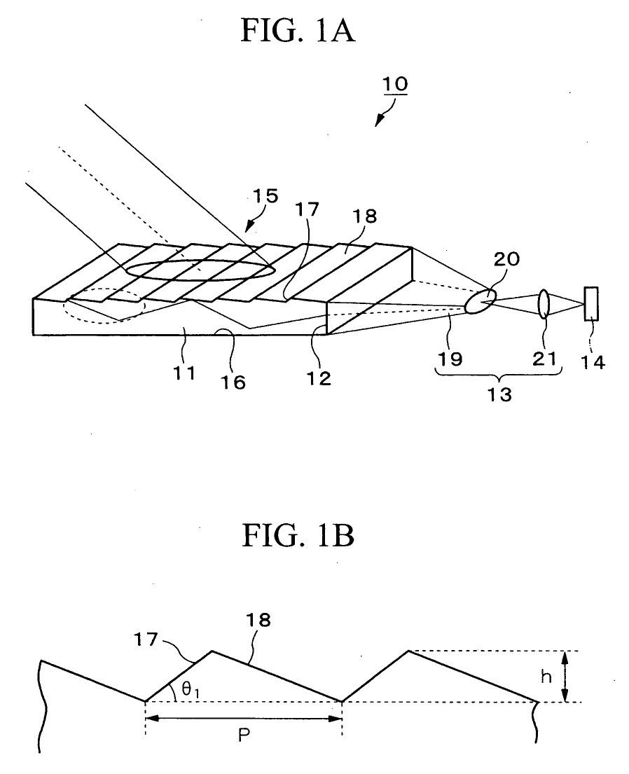

### DETAILED DESCRIPTION OF THE INVENTION

Hereinafter, an optical antenna according to a first embodiment of the present invention is explained with reference to drawings.

An optical antenna 10 according to the present embodiment is a system for receiving a signal light which is transmitted externally. As shown in FIGS. 10A and 10B, the optical antenna 10 comprises an optical waveguide board (optical waveguide member) 11, a light condensing member (light condensing member) 13 which is disposed so as to face an emergence surface 12 which is disposed on a side surface along a thickness direction of the optical waveguide board 11, and an light receiving element 14 which is disposed in a light condensing position in the light condensing member.

The optical waveguide board 11 has 1.2 mm thickness. The optical waveguide board 11 is made from an acrylic member. Also, an incidence surface 15 is disposed on a surface of the optical waveguide board 11 in the thickness direction. An longitudinal member and a latitudinal member of the incidence surface 15 is 50 mm×50 mm.

The above incidence surface 15 is provided with a slanted surface 17 which has an angle for reflecting a total light on a back surface 16 of the optical waveguide board 11, and another slanted surface 18 which reflects a light which is reflected on the back surface 16 totally so as to direct the reflected light toward the emergence surface 12.

The slanted surface 17 has a saw section in a direction toward the incidence surface 15 and the emergence surface 12. A slanting angle θ1 of the slanted surface 17 has 45° of angle with reference to the back surface 16. Also, the saw section has 0.2 mm of pitch. The saw has a height “h” such that “h” is formed so as to be larger farther from the light receiving element 14 gradually. An average height for “h” is approximately 4 μm. Although it depends on the angle at which the light is incident, by doing this, the optical waveguide plate 11 can introduce the light which is incident into the incidence surface 15 so as to transmit the introduced light to the emergence surface 12.

The light condensing member 13 is provided with a fiber taper (taper optical guiding member) 19 which is cemented on the emergence surface 12 on the optical waveguide plate 11 and a focusing lens 21 which focuses an image on an image surface 20 in the fiber taper 19 in the light receiving element 14.

The fiber taper 19 is formed by bundling optical fibers, extending a part of the bundled optical fibers, and cutting a narrow part of the extended optical fibers. Also, the fiber taper 19 is cemented on the emergence surface 12; therefore, it is possible to transmit an image of the emergence surface 12 on the optical waveguide plate 11 on the image surface 20 of the fiber taper 19 in a magnification scale such as ⅓.

The focusing lens 21 serves for further contracting an image on the image surface 20 on the fiber taper 19 so as to focus the contracted image on the light receiving element 14. Here, a focusing magnification ratio is ⅛ or smaller.

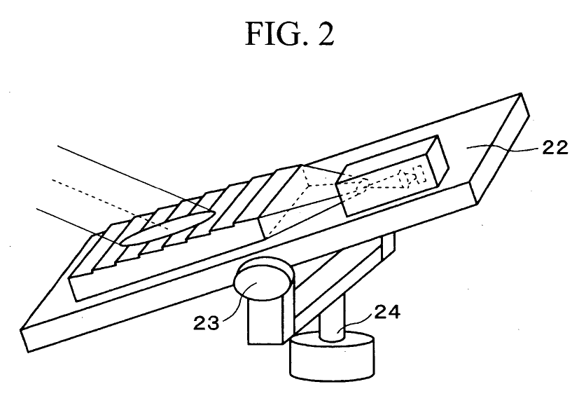

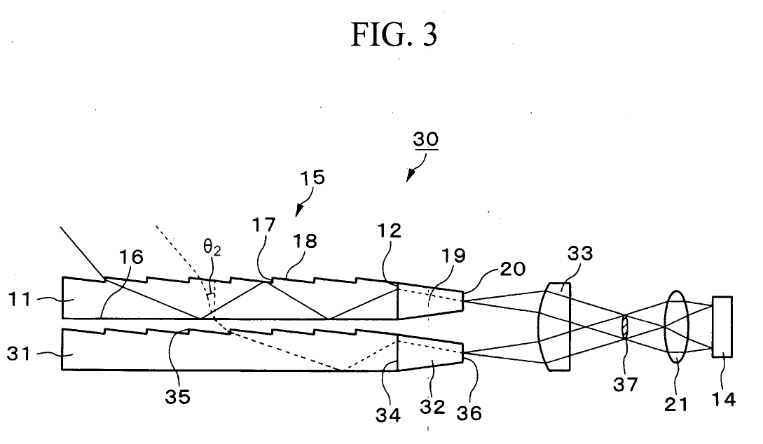

Also, the optical antenna 10 is disposed on a base board 22 as shown in FIG. 2. A middle section in the base board 22 is rotative around a rotation axis 23 in the optical antenna 10. Also, the middle section of the base board 22 is rotative around a rotation axis 24 in a radial direction. By doing this, it is possible to dispose the optical antenna 10 in any desirable direction.

Operations in the optical antenna 10 which is formed in this way in the present embodiment is explained as follows.

The rotation axes 23, 24 are rotated such that the slanted surface 17 which is formed in the incidence surface 15 on the optical waveguide plate 11 can be directed in a direction of the signal light so as to adjust a vertical angle direction and a horizontal angle direction for receiving the signal light which is transmitted externally by using the optical antenna 10 according to the present embodiment. The vertical direction and the horizontal direction are adjusted such that a maximum amount of the signal light is introduced in the optical waveguide plate 11 because the intensity of the signal light is weak for a middle-distance communication usage such as an inter-building communication condition. That is, the directions are adjusted such that the output of the light receiving element 14 should be maximum.

By doing this, if the signal light is incident into the incidence surface 15 on the optical waveguide plate 11, the signal light is introduced inside of the optical waveguide plate 11 from the slanted surface 17. The signal light is reflected on the back surface 16 on the optical waveguide plate 11 totally. The light which is reflected totally is reflected totally on another slanted surface 19. By doing this, the signal light is reflected inside of the optical waveguide plate 11 repeatedly totally until is it transmitted to the emergence surface 12.

The signal light which reaches to the emergence surface is transmitted to the image surface 20 via the fiber taper 19. The signal light which reaches to the image surface 20 is condensed on the light receiving element 14 by the focusing lens 21.

That is, the magnification ratio of the fiber taper 19 of the optical antenna 10 is ⅓ in the optical antenna 10 in the present embodiment. The magnification ratio of the focusing lens 21 is ⅛ or smaller; thus, the image on the emergence surface 12 is focuses on the light receiving element 14 by ½ of magnification ratio or smaller. Therefore, the width of the emergence surface 12 is 50 mm; thus, the size is 2 mm on the light receiving element 14. Therefore, it is possible to decrease the size of the area on the light receiving element 14. By doing this, it is possible to decrease the area for receiving the light in the light receiving element 14; therefore, it is possible to use a cheap light receiving element 14. Also, the optical waveguide plate 11 is made from an acrylic member; thus, it is possible to realize a light-weight optical waveguide plate 11. Therefore, it is possible to form a larger incidence surface 15; thus, there is an effect in that it is possible to align the optical axis to the signal light easily.

Here, in the present embodiment, it is adjusted such that the output of the light receiving element 14 should be maximum. The received light is intense in a middle distance communication use such as an in-house wireless LAN; therefore, it is acceptable if a threshold output is present so as to be adjusted to be greater than the threshold output.

Also, the slanting angle θ₁ of the slanted surface 17 is set at 45°. However, the slanting angle θ₁ of is not limited in a particular angle value. That is, it is acceptable as long as the angle is present so as to reflect the light totally on the back surface 16.

Hereinafter, an optical antenna according to a second embodiment of the present invention is explained with reference to drawings. Here, in the following embodiment, the same reference numerals are added to the members in the second embodiment which are the same as those in the first embodiment so as to omit duplications in the explanation.

The optical antenna 30 according to the present embodiment is different from the optical antenna 10 in the first embodiment in that the optical antenna 30 is provided with an optical waveguide plate 31 which has a similar shape with the optical waveguide plate 11, a fiber taper 32, and a lens 33 for a light condensing section.

The fiber taper 32 is cemented on an emergence surface 34 similarly to a case for the optical waveguide plate 11. In addition, the optical waveguide plate 31 is disposed such that a great portion of the light which transmits through the back surface 16 of the optical waveguide plate 11 should be incident into the slanted surface 35 on the optical waveguide plate 31.

The above lens 33 is disposed so as to have similar distance to the image surfaces 20, 36 of the fiber taper 19 such that the image surfaces 20, 36 should be the focal positions. By doing this, a pupil image 37 of the light which is emitted from the image surfaces 20, 36 is formed by a rear focal distance.

The above focusing lens 21 contracts the pupil image 37 so as to focus the contracted pupil image 37 on the light receiving element 14.

Operations in the optical antenna 30 which is formed in this way in the present embodiment is explained as follows.

The signal light which is incident into the slanted surface 15 is reflected totally inside the optical waveguide plate 11 repeatedly until the reflected light is transmitted to the emergence surface 12 similarly to a case for the first embodiment when the signal light which is transmitted externally is received by using the optical antenna 30 according to the present embodiment.

Here, the signal light which is incident into the another slanted surface 18 is incident into the back surface 16 of the optical waveguide plate 11 at an angle θ₂ which is smaller than a critical angle; thus, the light is transmitted therethrough because the light is not reflected totally. The light which is transmitted from the back surface 16 is incident into a slanted surface 35 of the optical waveguide plate 31 so as to be reflected inside of the optical waveguide plate 31 totally in a repeated manner until the reflected light is transmitted to the emergence surface 34.

By doing this, the signal light which is transmitted to the emergence surfaces 12, 34 by the optical waveguide plates 11, 31 forms a contracted image by transmitting through the fiber tapers 19, 32. These images are dubbed by the lens 33 so as to form the pupil image 37. The pupil image 37 is further contracted by the focusing lens 21 so as to be focused on the light receiving element 14.

That is, both signal lights which are transmitted through the optical waveguide plates 11, 31 are condensed on the light receiving element 14 by the optical antenna 30 according to the present embodiment. By doing this, a total part of the signal light which is leaked from the back surface 16 of the optical waveguide plate 11 is transmitted to the emergence surface 36 by the optical waveguide plate 31 so as to be introduced to the light receiving element 14; therefore, it is possible to restrict a loss in the signal light.

Hereinafter, an optical antenna according to a third embodiment of the present invention is explained with reference to drawings.

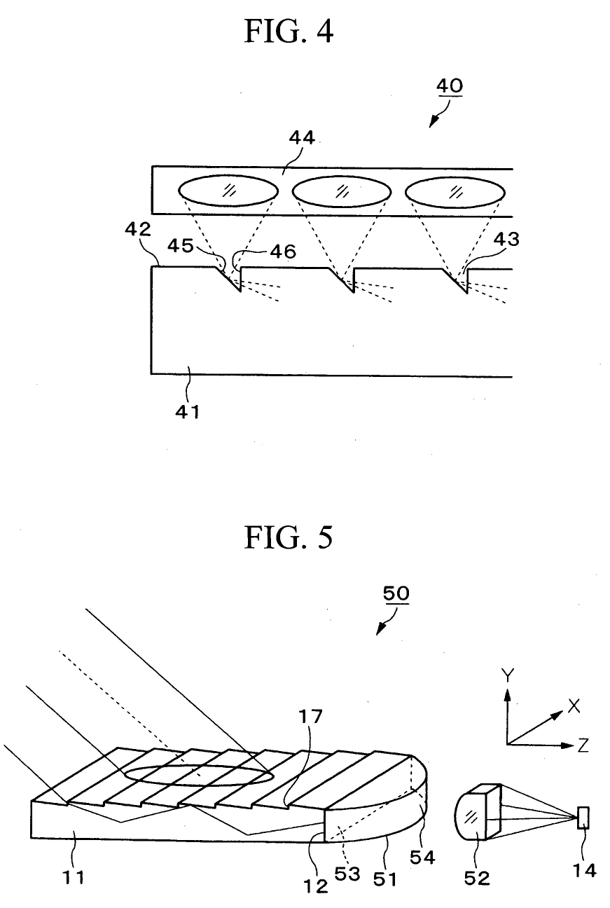

An optical antenna 40 according to the present embodiment is different from the optical antenna 10 according to the first embodiment in that the optical antenna 40 is provided with a V-groove (concave section) 43 which is disposed on the incidence surface 42 of the optical waveguide plate 41 and a lens array (light condensing lens) 44 as shown in FIG. 4.

The V-groove 43 has a first slanted surface 45 and a second slanted surface 46 on the incidence surface 42. A reflecting coating is formed on the first slanted surface 45 so as to reflect the incident light to an emitting direction.

The lens array 44 is disposed near the V-groove 43 such that the light which is incident toward the incidence surface 42 is condensed on the first slanted surface 45.

Operations in the optical antenna 40 which is formed in this way in the present embodiment is explained as follows.

A rotative axis 23 and a rotative axis 24 are rotated so as to adjust the direction of the optical antenna 40 such that the signal light is incident into the lens array 44 approximately orthogonally when the signal light which is transmitted externally by using the optical antenna 40 according to the present embodiment. By doing this, the signal light which is incident into the lens array 44 is condensed on the first slanted surface 45 of the V-groove 43. A reflecting coating is formed on the first slanted surface 45; therefore, the signal light which is condensed on the first slanted surface 45 is reflected toward the emitting direction so as to transmit through the optical waveguide plate 41 until the reflected light reaches to the emergence surface 12. Consequently, the light which reaches to the emergence surface 12 is detected by the light receiving element 14 similarly to a case for the first embodiment.

That is, the optical antenna 40 according to the present embodiment can condense the signal light which is incident toward the incidence surface 42 by the lens array 44 into the first slanted surface 45 of the V-groove 43. Therefore, it is possible to reflect a total incident signal light inside the optical waveguide plate 41 so as to transmit to the emergence surface 12. Therefore, the light receiving element 14 has a high receiving efficiency; thus, such a structure is desirable for a long distance optical aerial transmission communication system.

Hereinafter, an optical antenna according to a fourth embodiment of the present invention is explained with reference to drawings.

As shown in FIG. 5, an optical antenna 50 according to the present embodiment is different from the optical antenna 10 according to the first embodiment in that the light condensing section is provided with a cylindrical light condensing lens 51 and a lens 52.

A surface of the light condensing lens 51 is flat near the incidence surface 53. An X-Y cross section near the emergence surface 54 is a cylindrical lens surface of which convex surface is disposed toward the Z axis direction. The incidence surface 53 of the light condensing lens 51 is cemented on the emergence surface 12 of the optical waveguide plate 11. Furthermore, a reflecting coating is formed on an external part except a surface which contacts the emergence surface 12 and the emergence surface 54. By doing this, the signal light which is incident from the incidence surface 53 of the light condensing lens 51 does not leak to the outside of the light condensing lens 51 except a direction toward the lens 52.

The lens 52 is a cylindrical lens surface which is disposed so as to face the light condensing lens 51 such that a convex surface of Y-Z cross section is directed to a negative direction of the Z axis.

Operations in the optical antenna 50 which is formed in this way in the present embodiment is explained as follows.

The signal light which is incident into the slanted surface 17 is reflected totally inside the optical waveguide plate 11 repeatedly until the reflected light is transmitted to the emergence surface 12 similarly to a case for the first embodiment when the light which is transmitted externally is received by using the optical antenna 50 according to the present embodiment.

The signal light which reaches to the emergence surface 12 is incident from the incidence surface 53 of the light condensing lens 51 so as to be reflected thereinside so as to be transmitted to the emergence surface 54 of the light condensing lens 51. An X-Z cross section of the emergence surface 54 is formed in a convex shape; therefore, the signal light which is transmitted to the emergence surface 54 is refracted so as to be condensed in an X-Y plain so as to be directed to the lens 52. Furthermore, the signal light which is transmitted through the lens 52 is refracted so as to be condensed in the Y-Z plain so as to be detected by the light receiving element 14.

That is, the optical antenna 50 according to the present embodiment uses a cylindrical light condensing lens 51 and the lens 52 for a light condensing section for condensing the signal light from the emergence surface 12 in the light receiving element 14. By doing this, the light condensing lens 51 and the lens 52 can be manufactured by using an injection mold for an optical plastic member. Therefore, it is possible to perform a mass-production; therefore, there is an effect in that it is possible to realize a cheap optical antenna 50.

Here, in the present embodiment, the emergence surface 12 of the optical waveguide plate 11 and the incidence surface 53 of the light condensing lens 51 are cemented. It is possible to manufacture the light condensing lens 51 and the lens 52 by using an injection mold; therefore, it is possible to manufacture the light condensing lens 51 and the lens 52 under a cemented condition in advance. In addition, the emergence surface 54 of the light condensing lens 51 is formed in a free-curved surface in which the curvature in the X axis direction and the curvature in the Y axis direction are different from each other. By doing this, it is possible to condense the signal light in the light receiving element 14 without using the lens 52. In such a case, an optical parts which is manufactured in an injection molding operation is an optical waveguide board which is formed by an optical waveguide board 11, the light condensing lens 51, and the lens 52. By doing this, it is possible to manufacture such an optical parts in a mass production.

Hereinafter, an optical antenna according to a fifth embodiment of the present invention is explained with reference to drawings.

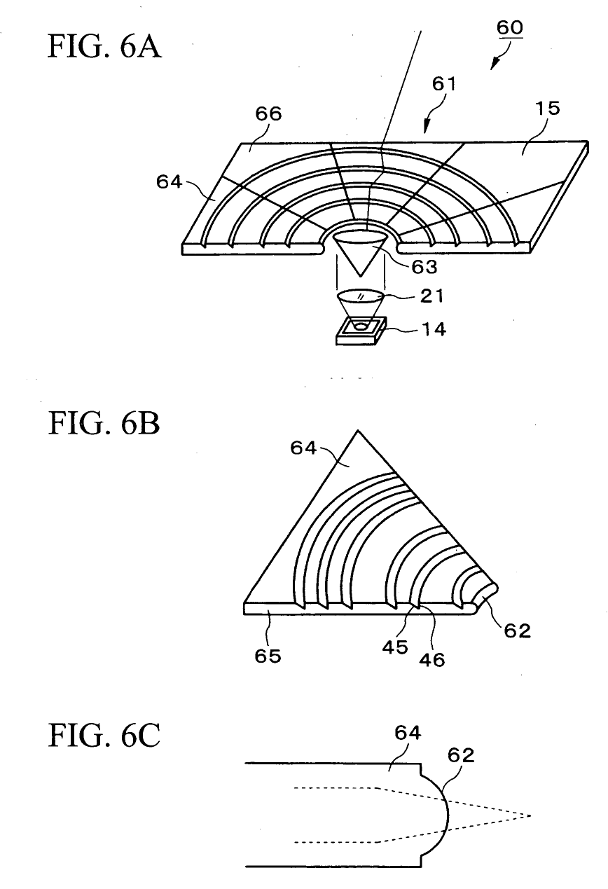

As shown in FIGS. 6A to 6C, the optical antenna 60 according to the present embodiment is different from the optical antenna 40 according to the third embodiment in following features. The shape of the optical waveguide plate 61 is different. The emergence surface 62 is formed in a convex surface. The optical antenna 60 is a conical mirror 63 in place of the fiber taper 32.

As shown in FIG. 6A, the optical waveguide plate 61 is formed by attaching a plurality of sector optical waveguide boards 53 of which width is smaller nearer to the emergence surface 62. Side surfaces 65 which are disposed on both sides of the optical waveguide plate 64 in a width direction are mirror surfaces on which a reflecting coating and a mirror surface finish are formed. By doing this, it is avoided that the signal light which transmits in the optical waveguide plate 64 be scattered from the side surfaces 65 to the inside of the optical waveguide plate 64. Also, the first slanted surface 45 and the second slanted surface 46 of the optical waveguide plate 61 are formed in a concentric circle.

The above emergence surface 62 is formed in a convex surface; therefore, the emergence surface 62 condenses the light which is emitted from the emergence surface 62 so as not to be scattered in the thickness direction of the optical waveguide plate 61.

The above conical mirror 63 is disposed so as to face the emergence surface 62 so as to reflect the light which is emitted from the emergence surface 62 toward a tip of the cone on a side surface of the conical mirror 63. Also, the focusing lens 21 is disposed near a tip of the conical mirror 63; therefore, the light which is reflected by the conical mirror 63 is focused in the light receiving element 14 by the focusing lens 21.

Operations in the optical antenna 60 which is formed in this way in the present embodiment is explained as follows.

A signal light is incident into the incidence surface 15 of the optical waveguide plate 61 for receiving the signal light which is transmitted externally by using the optical antennal 60 according to the present embodiment. In such a case, the first slanted surface 45 is concentric. Also, the side surfaces 65 of the sector optical waveguide board 64 are formed in a mirror surface finish. Therefore, the total signal light which is incident into the optical waveguide plate 61 is reflected in a repeated manner so as to be transmitted toward the emergence surface 62 in a converging manner. The signal light which reaches to the emergence surface 62 is emitted so as not to be scattered in the thickness direction because the emergence surface 62 is formed in a convex surface. The emergence light signal is reflected by the conical mirror 63 so as to be reflected to the direction of the focusing lens 21. In addition, the signal light is focused by the focusing lens 21 so as to be detected by the light receiving element 14.

That is, in the optical antenna 60 according to the present embodiment, it is possible to condense the incident light in the light receiving element 14 so as to be detected even if the light is incident in any horizontal direction. Therefore, the present invention is desirable for the optical antenna which is used for a movable structure in which a direction of the light is not constant.

Here, a conical mirror 63 is used in the present embodiment. However, the present invention is not limited to such a structure. Here, it is acceptable if a pyramid mirror is used.

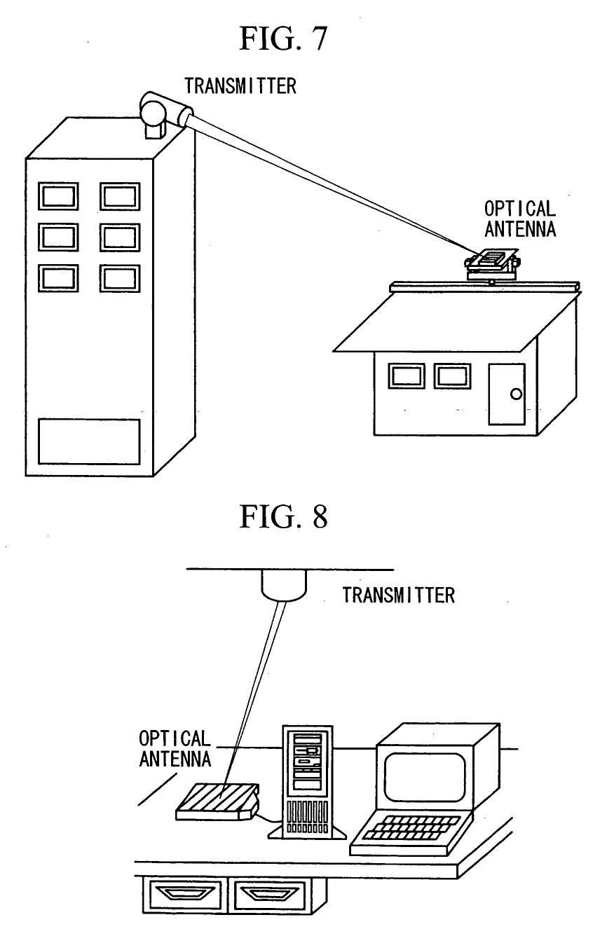

It is possible to use the optical antenna according to the above explained embodiments in various optical aerial transmission communication systems. For example, it is possible to receive an optical wireless broadcasting program as shown in FIG. 7. Also, it is possible to use the optical antenna of the present invention in an in-house optical wireless LAN as shown in FIG. 8.

As explained above, according to the optical antenna of the present invention, it is possible to form a large incidence surface for receiving the signal light which is transmitted externally. Therefore, it is possible to align the signal light easily; thus, it is possible to receive the signal light easily. Also, it is possible to manufacture the optical waveguide plate by an acrylic member, etc.; therefore, it is possible to realize a light-weight device. Also, it is possible to manufacture the optical waveguide plate in a mass-production. Therefore, it is possible to realize a cost reduction effect.

According to the present invention, a part of the light which is incident from the incidence surface is incident from the slanted surface. Such a light is reflected totally on the back surface of the optical waveguide member so as to be directed to the emergence surface. It is possible to understand that the light which reaches to the emergence surface is a two-dimension light source for the signal which has a flat surface shape. By doing this, the flat light flux which is emitted from this emergence surface is condensed in an approximate point by the light condensing member so as to be detected in the light receiving element. Therefore, it is possible to enlarge the incidence surface. Therefore, it is possible to form a an optical antenna in which it is possible to align the optical axis with the light.

According to these inventions, it is possible to reflect a total light which is incident from the slanted surface on the back surface so as to transmit to the emergence surface. Therefore, the light receiving element has a high receiving efficiency; thus, such a structure is desirable for a long distance optical aerial transmission communication system.

According to these inventions, it is possible to transmit the incident light to the light receiving element even if a light is incident from any horizontal direction. Therefore, the present invention is desirable for the optical antenna which is used for a movable structure in which a direction of the light is not constant.

According to these inventions, it is possible to contract the image in the emergence surface so as to be focused in the light receiving element. By doing this, it is possible to decrease the area for receiving the light in the light receiving element; therefore, it is possible to use a cheap light receiving element. If the light condensing member has an optical element in which a focal distance is different between a width direction and the thickness direction of the optical waveguide member, it is possible to manufacture such an optical element by an injection mold for an optical plastic member. Therefore, it is possible to perform a mass-production. By doing this, it is possible to form a a cheap optical antenna.

According to the present invention, it is possible to condense a light which is incident into the incidence surface in a slanted surface by the light condensing lens. Therefore, it is possible to reflect a total incident light inside the optical waveguide member so as to transmit to the emergence surface.

What is claimed is:

1. An optical antenna which includes a transparent flat board member.

2. An optical antenna comprising:
a flat board optical guide member made of a transparent member which has an incidence surface on a surface along a thickness direction and an emergence surface on the other surface which is disposed along the thickness direction; and
a light receiving element which receives the emergence light from the emergence surface.

3. An optical antenna comprising:
a flat board optical guide member which has an incidence surface on a surface in a thickness direction and an emergence surface on the other surface;
a light condensing member which is disposed so as to face the emergence surface of the optical guide member;
a light receiving element which is disposed in a light condensing position in the light condensing member,
wherein a slanted surface for reflecting a total incident light on a back surface of the optical guide member so as to direct the reflected incident light toward the emergence surface.

4. An optical antenna according to claim 3 wherein a plurality of the slanted surface are disposed so as to have intervals in a direction toward the emergence surface.

5. An optical antenna according to claim 3 wherein the slanted surface has and angle of 45° with reference to a back surface of the optical guide member.

6. An optical antenna according to claim 5 wherein a partial concave section is disposed on the incidence surface and the slanted surface is disposed inside of the concave section.

7. An optical antenna according to claim 6 wherein a reflecting coating is formed on the slanted surface.

8. An optical antenna according to claim 7 wherein the slanted surface is formed in a circular shape such that the diameter of the circle is smaller nearer to the emergence surface.

9. An optical antenna according to claim 8 wherein:
the optical guide member is formed in a sector such that a width of the optical guide member is narrower nearer to the emergence surface; and
a reflecting coating is formed on a side surfaces on both ends of the width direction.

10. An optical antenna according to claim 9 wherein the light condensing member is provided with a taper optical waveguide member which is cemented to the emergence surface and a focusing lens for focusing a light which is emitted from the taper optical guiding member on a light receiving element.

11. An optical antenna according to claim 10 wherein the light condensing member is formed by optical element which has different focal distance in a width direction and a thickness direction of the optical guide member.

12. An optical antenna according to claim 11 wherein a light condensing lens for condensing a light on the slanted surface is disposed in a front stage of the incidence surface.
